(19) United States
(12) Patent Application Publication
(10) Pub. No.: US 2017/0210237 A1
(43) Pub. Date: Jul. 27, 2017

(54) Vehicle Charging Station Comprising A Two-Membered Manipulator

(71) Applicant: SIEMENS AKTIENGESELLSCHAFT, MUENCHEN (DE)

(72) Inventors: FLORIAN BUEHS, BERLIN (DE); ANDREAS LASKE, BERLIN (DE); ANDRE ROMPE, BERLIN KAULSDORF (DE)

(73) Assignee: SIEMENS AKTIENGESELLSCHAFT, MUENCHEN (DE)

(21) Appl. No.: 15/328,096

(22) PCT Filed: Jun. 24, 2015
(86) PCT No.: PCT/EP2015/064255

§ 371 Date: Jan. 23, 2017

(30) Foreign Application Priority Data
Jul. 23, 2014 (AT) A50510/2014

(51) Int. Cl. B60L 11/18; H02J 7/00; H01M 10/44

(52) U.S. Cl. CPC B60L 11/1827; H01M 10/44; H02J 7/0021; H02J 7/0045; B60L 11/1816; H01M 2220/20; B60L 2200/18; B60L 2230/10

(57) ABSTRACT

A vehicle charging station charges an energy accumulator of a battery-driven vehicle. The charging station contains a base disposed in the vicinity of the pre-defined parking position and a two-membered manipulator having a first member, one end of which is mounted in a revolute joint on the base and is rotary driven by a rotary drive and the other end is connected to a first end of a second member by a second revolute joint. The second revolute joint is rotary driven by a second rotary drive. The other end of the second member is connected to a supply-contact device, such that, by a rotary motion of the first member and/or the second member, electrical contact is made between contact elements of the supply-contact device and contact elements of a receiving-contact device. The contact elements are permanently connected to the vehicle roof or a side wall of the vehicle.

### TECHNICAL FIELD

The invention relates in general to the technical field of electric vehicles, in particular to a vehicle charging station and to a method for charging, and to a battery-driven, non-railbound vehicle.

### PRIOR ART

In local public transportation, battery-driven transport systems have long been known, for example from DE 24 05 198. Fully electric buses, the entire energy requirements of which are covered by the battery system carried on the vehicle, have recently been put into service. In the metropolitan area of Vienna, fully electric buses of this type are currently in service which obtain their drive power completely from a plurality of lithium ferrite batteries carried on the vehicle, said batteries having a total capacity of approximately 100 kWh. The batteries are accommodated on the roof and/or at the rear of the vehicle. These batteries are recharged within approximately 15 minutes during service hours, in each case at a terminal station on the bus line, and overnight when the fully electric bus is not in service. For charging, a button is pressed to extend a pantograph provided on the vehicle roof of the electric bus and to bring said pantograph into contact with a catenary line system above the electric bus. Before the start of the journey, the contact with the catenary line system is broken, again by a manual switching operation.

A disadvantage here is that the pantograph, together with the lifting and lowering device, has to be carried on the vehicle roof. This calls for additional drive power and reduces the payload of the vehicle. In addition, the lifting and lowering device comprises a plurality of moving parts. On the roof, the device, together with the drive technology, is exposed to the weather and is susceptible to faults. The design of the extendable pantograph takes up structural space on the vehicle roof which reduces the clearance height of the electric bus. Manual operations are required for the charging process. A charging process which proceeds automatically would be desirable.

### DESCRIPTION OF THE INVENTION

An object of the present invention is to avoid the aforementioned disadvantages and to establish an approach by means of which as far as possible no moving parts of the on-board contact device are required for charging the energy accumulator of a battery-driven vehicle and the charging process can to a large extent be automated.

The object is achieved in a vehicle charging station according to the features of claim 1 and in a method for charging according to the features of claim 10 and in a vehicle according to claim 13.

The device-related object is achieved in that the following is provided:
a) a base which is arranged in the vicinity of the pre-defined parking position;
b) a multi-membered manipulator having a first member, one end of which is mounted in a revolute joint on the base and is rotary driven by means of a rotary drive, and the other end of which is connected to a first end of a second member by means of a second revolute joint, said second revolute joint being likewise rotary driven by means of a second rotary drive, the other end of the second member being connected to a supply-contact device, such that, by means of a rotary motion of the first member and/or the second member an electrical contact can be made between contact elements of the supply-contact device and corresponding contact elements of a receiving-contact device, the contact elements of which receiving-contact device are permanently connected to the vehicle roof or a side wall of the vehicle.

As the electrical contact during charging is established by means of a station-side manipulator, no on-board pantograph with moving parts is required. The object of contacting is taken over by a manipulator fashioned in the manner of an articulated-arm robot, so the process of charging can proceed automatically. The on-board contact device is formed by fixed contact elements which are fixedly mounted either on the vehicle roof or on a side wall of the vehicle.

A substantial advantage is firstly that moving parts are no longer needed on board the vehicle.

A further advantage arises from the fact that the at least two-membered design of the manipulator makes it possible to compensate for the parking position of the vehicle. Even if the vehicle is not located exactly in the predefined parking position, the supply-contact device can be docked onto the vehicle. The two-membered design as a vertically articulated arm makes it possible for the clamping force between the contact surfaces to be maintained even if the bus moves during the charging process, for example, because persons embark or disembark.

It is favorable if the contact elements of the receiving-contact device are fashioned in the form of elongated contact strips which are arranged in the plane of the vehicle roof or of the side wall of the vehicle or in a plane parallel thereto. The contact surfaces of these contact strips can be kept comparatively small in terms of their dimensions so that the on-board contact device on the vehicle roof or on a side wall takes up only a small space. One of the advantages of this is that the on-board contact device can be arranged on both halves of the vehicle roof so that the bus can be charged from both sides, for example, even if driven into the parking position in the opposite direction to that envisaged.

It can be particularly favorable if the supply-contact device consists of four contact strips which are arranged in the shape of a cross and is fashioned such that an electrical contact can be made with four corresponding contact strips of the receiving-contact device, said corresponding contact strips being arranged in the shape of a square or rectangle.

In another particularly preferred embodiment, precisely the opposite is true: the supply-contact device consists of four contact strips which are arranged in the shape of a rectangle and the four corresponding contact strips of the receiving-contact device are arranged in the shape of a cross.

The advantage of these two particularly preferred embodiments is that the requirement for precision with regard to the positioning accuracy of the vehicle in the parking position can be reduced. In other words, the cross/square contact arrangement creates an advantageous range of tolerance in respect of the positioning accuracy for contacting, both in the direction of travel and in the lateral distance of the vehicle relative to the base.

A further advantageous design can be one in which not only are each of the articulated joints between the first member and the base and the second member and the first member driven by a rotary drive, but so is the articulated joint between the supply-contact device and the second member. This makes it possible to correct the position of the supply-contact device shortly before docking such that even in the event of the vehicle standing at a tilt caused by asymmetrical loading, the corresponding contact elements will lie opposite one another at approximately the same distance apart.

The method-related object is achieved in a method for charging the energy accumulator in a battery-driven vehicle, in particular an electric bus or a hybrid vehicle, the vehicle parking, for the purpose of charging, in a pre-defined parking position, with a vehicle charging station, comprising:
i. a base (2) which is arranged in the vicinity of the pre-defined parking position;
ii. a multi-membered manipulator having a first member, one end of which is mounted in a revolute joint on the base and is rotary driven by means of a rotary drive, and the other end of which is connected to a first end of a second member by means of a second revolute joint, said second revolute joint being likewise rotary driven by means of a second rotary drive, the other end of the second member being connected to a supply-contact device.
iii. The method is characterized by the method step that by means of a rotary motion of the first member and/or the second member an electrical contact is made between contact elements of the supply-contact device and corresponding contact elements of a receiving-contact device, the contact elements of which receiving-contact device are permanently connected to the vehicle roof or to a side wall of the vehicle.

Motion of the individual members of the manipulator in a swivel plane (y-z plane) which is oriented approximately transverse to the direction of the longitudinal extension of the parking vehicle (x direction) is preferable here. Starting from an idle position, the docking onto the vehicle follows the “shortest” path.

In one embodiment, the rotary motion of the first member and/or of the second member proceeds automatically, controlled by a control device.

The object is also achieved in a battery-driven, non-railbound vehicle having a receiving-contact device with strip-shaped contact elements which are arranged in the shape of a cross or of a rectangle on the vehicle roof or on a lateral surface of the vehicle.

An easy way of fastening the individual contact elements is to embed them in a plate-shaped electrical insulator, the elements projecting from the plane of the plate.

To drain moisture away, it is favorable here if the plate-shaped insulator has the shape of a truncated pyramid and the contact elements are arranged approximately in the area of the edges of the top surface of the truncated pyramid.

### BRIEF DESCRIPTION OF THE DRAWINGS

In order to explain the invention further, reference will be made in the part of the description below to drawings in which further advantageous designs, details and further developments of the invention, based on a non-restrictive exemplary embodiment, can be found, in which

FIG. 1 shows a vehicle charging station having a manipulator which consists of two moving members, in a schematic side view;

FIG. 2 shows FIG. 1 in a plan view;

FIG. 3 shows three different idle positions of the two-membered manipulator;

FIG. 4 shows an embodiment of the manipulator in which the first member is fashioned as a disk;

FIG. 5 shows three different arrangements of strip-shaped contact elements of the receiving-contact device;

FIG. 6 shows a preferred arrangement of corresponding contact elements, wherein contact elements arranged in the shape of a star lie opposite contact elements arranged in a square or rectangle;

FIG. 7 shows an arrangement of four contact elements arranged in a square which are embedded in an insulator fashioned as a truncated pyramid and project from the top surface of the truncated pyramid;

FIG. 8 shows a cross-shaped arrangement of four contact elements.

### EMBODIMENT OF THE INVENTION

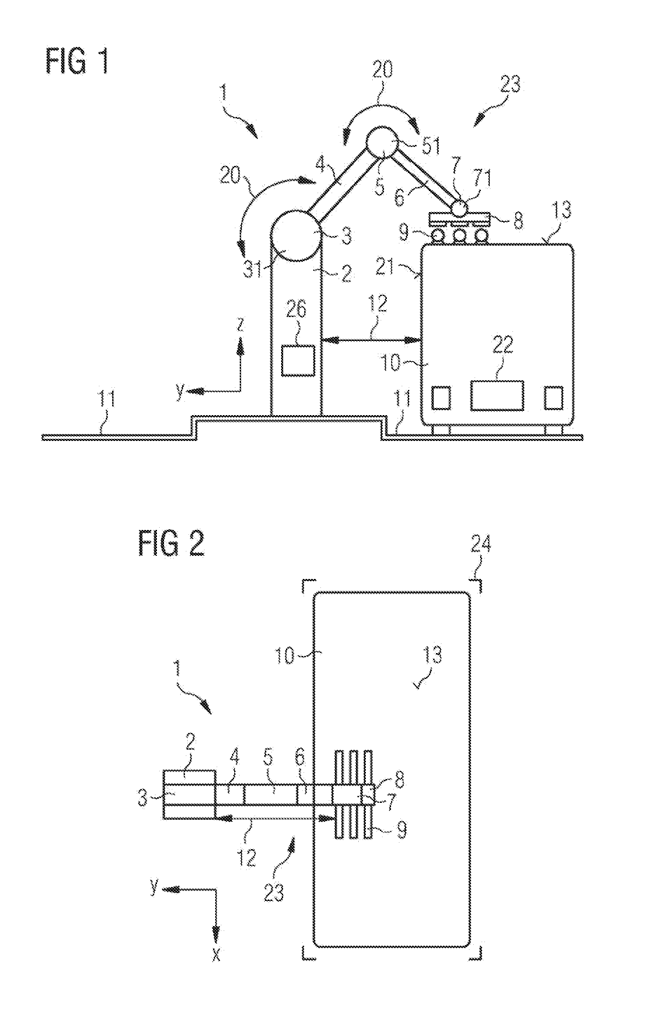

FIG. 1 shows in a schematic side view an embodiment of a charging station 1. The charging station consists essentially of a pillar-shaped base frame or base 2 and a manipulator 23 fashioned as an articulated-arm robot. Said manipulator consists of a first member 4 and a second member 6, which are connected to one another by means of a joint 5. Each of the joints 3, 5 is coupled to a rotary drive 31, 51 respectively, which is not shown in detail. The axes of these rotary drives 31, 51 are parallel to one another and are oriented in the x direction, i.e. the longitudinal direction of a vehicle 10 parking within range of the manipulator 23.

The vehicle 10 may be e.g. a fully electric bus of the type referred to in the introduction having a lithium ferrite accumulator which is charged in bus terminal stations.

The second arm 6 carries on its outer end a supply-contact device 8. When rotated about the axes of the joints 3 and 5 (see double-headed arrows 20 in FIG. 1), this supply-contact device 8 can be swiveled to a vehicle 10 parking in the vicinity of the base 2 and can dock onto a receiving-contact device 9 arranged on the vehicle roof 13 or on a side wall 21 of the vehicle 10. The contact elements of the supply-contact device 8 are connected to a power source which is not shown in detail in the drawing, for example to a power supply network (catenary system); the on-board contact elements of the contact device 9 are connected to the battery 22 arranged in the vehicle 10, by which means the battery 22 can be charged.

If the contacts of the contact devices 8, 9 are appropriately dimensioned, it suffices if the vehicle is located inside the markings of the parking position 24.

The dimension of the contacts can be smaller if the exact position of the vehicle 10 is known.

In order to determine the exact position of vehicle 10 in the parking position 24, a position-detecting device can be provided in the base 2, by means of which position-detecting device for example the distance 12 (y direction) to the vehicle and the precise x position in the parking position 24 can be determined. The detection of the position may for example be realized optically, by means of ultrasound or via radio.

The drives 31,51,71 are electrical positioning drives controlled by a control unit 26. The control unit 26 is located in the base 2. The control unit 26 controls the process for the establishment of the electrical connection between the contact devices 8,9 fully automatically. Hydraulic or pneumatic drives can also be used.

The swiveling motion of the members 4,6 occurs in a swivel plane (y-z plane) which is realized approximately transverse to the direction of the longitudinal extension of the parking vehicle (x direction).

FIG. 2 shows a plan view of the working position of the manipulator 23 shown in FIG. 1, in which position the energy accumulator 22 of the vehicle 10 is charged. As shown in FIG. 2, the vehicle 10 is located in a defined parking position 24, i.e both in the direction of travel (x direction) and in the lateral distance 12 relative to the base 2 (y direction) within predefined markings.

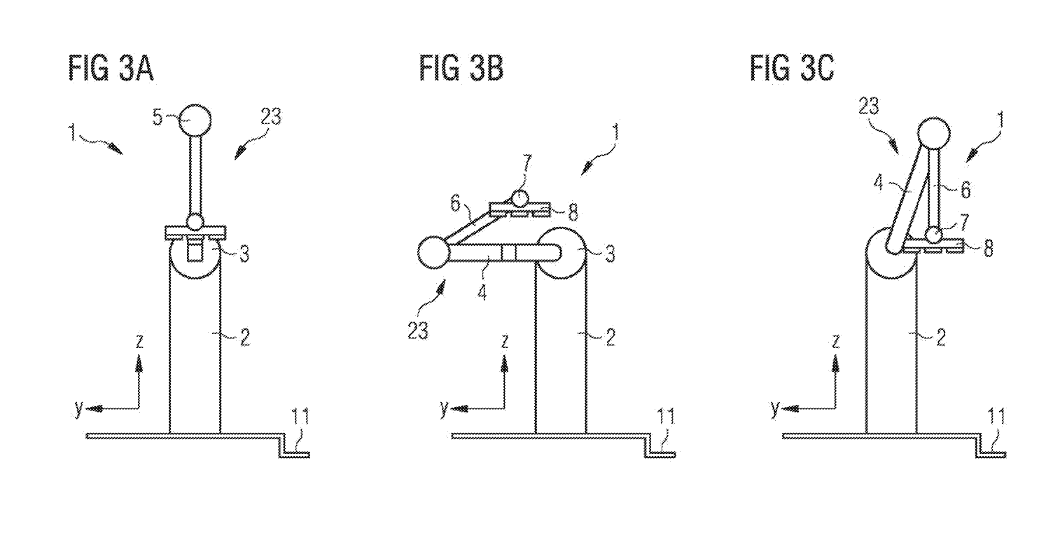

FIG. 3 shows idle positions of the manipulator 23 in three different settings. In FIG. 3a, the two members 3,4 are arranged vertically. In FIG. 3b, the first member 4 of the manipulator 23 is arranged approximately horizontally, the second member 6 at an angle to the horizontal. In the representation of the manipulator in FIG. 3c, the first arm 4 is inclined relative to the vertical, and the second arm 6 points vertically downward (z direction). In this way, different requirements of the installation location of the vehicle charging station 1 can be taken into account.

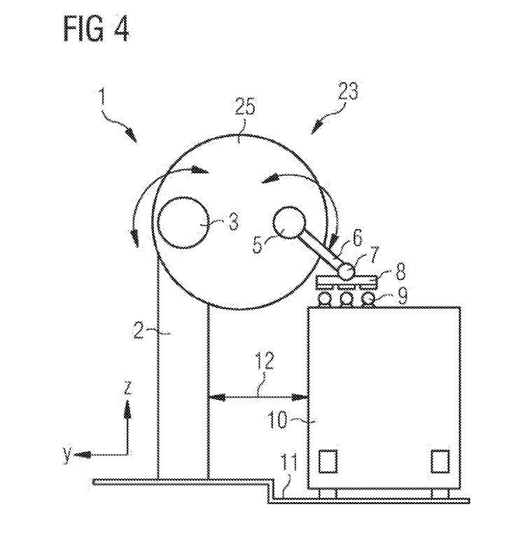

FIG. 4 shows another design of the manipulator 23, the first member being fashioned as a rotary disk 25. The rotary disk 25 is again mounted in a rotary-driven manner relative to the base 2 in a joint 3, the second member 6 is mounted eccentrically with the disk in a revolute joint 5. The position of the members 25 and 6 shown in FIG. 4 again corresponds to the working position, i.e. to the charging position.

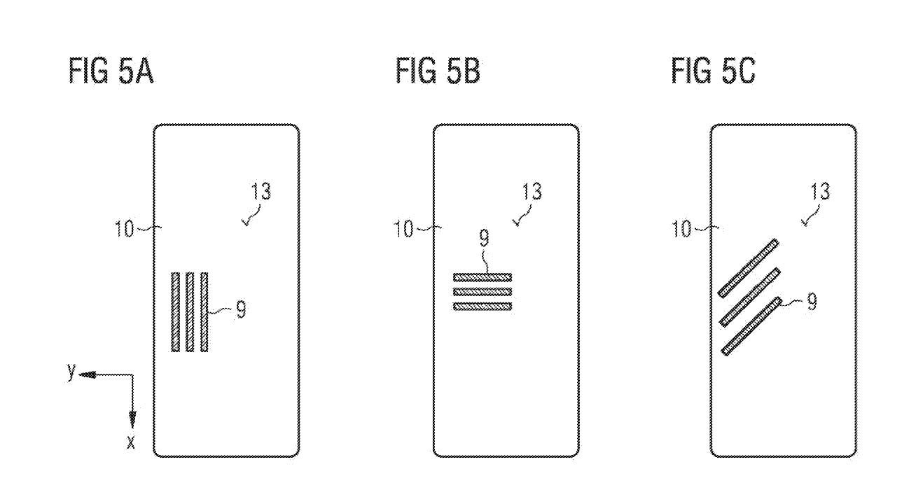

FIG. 5 shows various embodiments and variants of the orientation of the contact elements on the vehicle roof 13. In FIG. 5a, the contacts are oriented in the longitudinal direction of the vehicle 10, in FIG. 5b transverse to the longitudinal direction of the vehicle 10 and in FIG. 5c obliquely relative to the longitudinal direction of the vehicle 10. With regard to tolerance in the parking position, the embodiment according to FIG. 5a sets lower requirements with regard to imprecisions in the direction of travel, and the embodiment in FIG. 5b tolerates lateral deviations relative to the base 2 within a tolerance range. The embodiment according to FIG. 5c tolerates within limits imprecisions in the parking position 24 of the vehicle 10 both in the lateral distance 11 relative to the base 2 (y direction) and in the direction of travel (x direction)

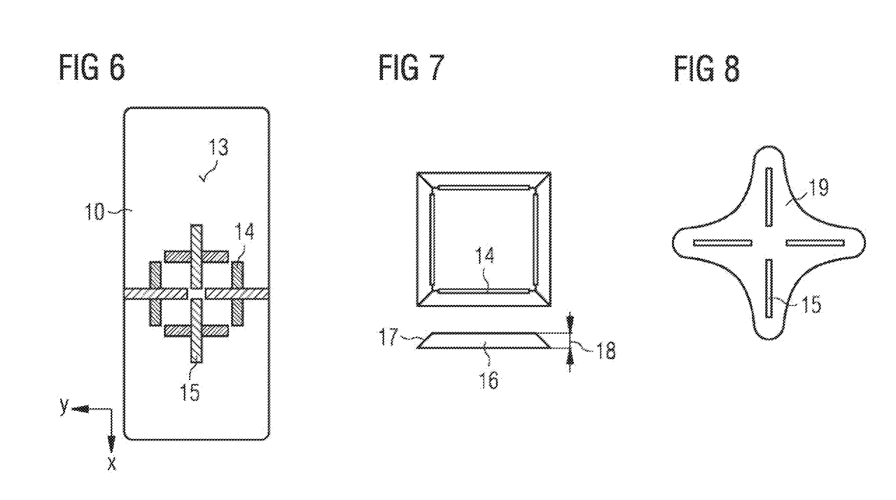

A particularly preferred embodiment of the contact devices 8 and 9 is shown in FIGS. 6, 7 and 8. Characteristic of these is that in the establishment of the electrical connection between vehicle charging station 1 and vehicle 10 a cross-shaped or square arrangement of station-side contact elements is brought into contact with on-board contact elements which are arranged in the shape of a square or in the shape of a cross, respectively. The advantage of this embodiment lies in a greater tolerance range for the parking position, both in the direction of travel (x direction) and transverse to the direction of travel (y direction)

FIG. 6 shows a plan view of the vehicle roof 13, with the contact elements 15 arranged in the shape of a cross and the contacts 14 arranged in a square, respectively. If contact elements of the supply contact device 8 are arranged in the shape of a cross, then the contact elements of the on-board contact device 9 are arranged in the shape of a square, or conversely, if station-side in the shape of a square, then the contact elements on the vehicle roof 13 are arranged in the shape of a cross.

FIG. 7 shows an arrangement of four contact elements arranged in a square which are embedded in an insulator 16 fashioned as a truncated pyramid and project from the top surface. The truncated pyramid has a height 18 between base surface and top surface. If truncated pyramid is mounted with its base surface on a vehicle roof 13, the inclined lateral surfaces 17 facilitate rainwater drainage.

FIG. 8 shows a cross-shaped arrangement of four contact elements 15 which are likewise at least partially embedded in an insulating part 19 (contact plate). In the representation in FIG. 8, this insulating part 19 is likewise fashioned in the shape of a cross.

A substantial advantage of the invention is that moving contact elements are no longer required on board the vehicle. Without major changes to the silhouette of the vehicle, the contacts of the receiving-contact device 9 can either be arranged flush with the vehicle roof 13 or a side wall 21, or lie in a plane parallel thereto.

In the case of an arrangement of contacts on the roof, it is possible for both halves of the vehicle roof to be fitted with contacts, as a result of which the vehicle 10 can enter the parking position 24 in either direction of travel (in the x direction or in the opposing direction). As shown graphically in FIG. 1, the manipulator 23 can serve vehicle 10 on either side of the base 2 depending on the direction of rotation (double-headed arrow 20).

Although the invention has been illustrated and described in detail by means of the preferred embodiments above, the invention is not as a consequence restricted to the disclosed examples. Other variations may be derived herefrom by one skilled in the art without departing from the scope of protection of the invention.

Thus, the number of contacts is of course not restricted to three (positive, negative, ground) and may comprise multiple contacts. The manipulator may be formed of more than two members.

The receiving contact device does not have to be arranged on the vehicle roof or side wall, it is also conceivable for the on-board contact device to be located on the rear of the vehicle.

### SUMMARY OF THE REFERENCE SIGNS USED

1 vehicle charging station
2 base
3 first revolute joint
4 first member
5 second revolute joint
6 second member
7 third revolute joint
8 supply-contact device
9 receiving-contact device
10 vehicle
11 road
12 distance
13 vehicle roof
14 rectangular arrangement of contact elements
15 cross-shaped arrangement of contact elements
16 contact plate
17 inclined lateral surface
18 thickness of the contact plate 16
19 contact plate
20 double-headed arrow
21 side wall
22 energy accumulator
23 manipulator
24 parking position
25 rotary disk
26 control unit
31 first rotary drive
51 second rotary drive
71 third rotary drive

1-14. (canceled)

15. A vehicle charging station for charging an energy accumulator of a battery-powered vehicle, the battery-powered vehicle parking in a pre-defined parking position during a charging process, the vehicle charging station comprising:
a base disposed in a vicinity of the pre-defined parking position;
a first revolute joint disposed on said base;
a first rotary drive;
a second revolute joint;
a second rotary drive;
a supply-contact device having contact elements; and
a multi-membered manipulator having a first member and a second member, said first member having a first end being rotatably mounted in said first revolute joint and is rotary driven by means of said first rotary drive, and a second end of said first member being connected to a first end of said second member by means of said second revolute joint, said second revolute joint being rotary driven by means of said second rotary drive, wherein a second end of said second member is connected to said supply-contact device, such that, by means of a rotary motion of at least one of said first member or said second member, an electrical contact can be made between said contact elements of said supply-contact device and corresponding contact elements of a receiving-contact device of the battery-powered vehicle, the corresponding contact elements of the receiving-contact device are permanently connected to a vehicle roof or a side wall of the battery-powered vehicle.

16. The vehicle charging station according to claim 15, wherein said supply-contact device is configured to make the electrical contact with said associated contact elements being contact strips of the receiving-contact device, said contact strips being disposed in a plane of the vehicle roof or of the side wall of the battery-powered vehicle or in a plane parallel thereto.

17. The vehicle charging station according to claim 16, wherein said supply-contact device is configured to make the electrical contact with at least three elongated said contact strips of the receiving-contact device, the contact strips being disposed either in a longitudinal extension of the battery-powered vehicle or transverse to the longitudinal extension of the battery-powered vehicle or at an angle to the longitudinal extension of the battery-powered vehicle.

18. The vehicle charging station according to claim 16, wherein said contact elements of said supply-contact device are four contact strips which are disposed in a shape of a cross and are fashioned such that the electrical contact can be made with four corresponding said contact strips of the receiving-contact device, said four corresponding contact strips being disposed in a shape of a rectangle.

19. The vehicle charging station according to claim 16, wherein said contact elements of said supply-contact device are four contact strips which are disposed in a shape of a square or a rectangle and are fashioned such that the electrical contact can be made with four corresponding said contact strips of the receiving-contact device, the corresponding contact strips being disposed in a shape of a cross.

20. The vehicle charging station according to claim 15, further comprising a third revolute joint, a connection between the second end of the second member and said supply-contact device is established by means of said third revolute joint.

21. The vehicle charging station according to claim 20, further comprising a third rotary drive, said third revolute joint is rotary driven by means of said rotary drive.

22. The vehicle charging station according to claim 15, wherein by means of said first and second rotary drives, said first and second members of said multi-membered manipulator are movable in a swivel plane which is oriented approximately transversely to the longitudinal extension of the battery-powered vehicle.

23. A method for charging an energy accumulator in a battery-powered vehicle, the battery-powered vehicle, for a purpose of charging, parks in a pre-defined parking position, which comprises the steps of:
providing a vehicle charging station having a base disposed in a vicinity of the pre-defined parking position and a multi-membered manipulator with a first member and a second member, the first member having a first end mounted in a revolute joint on the base and is rotary driven by a first rotary drive, and a second end of the first member is connected to a first end of the second member by means of a second revolute joint, the second revolute joint is rotary driven by means of a second rotary drive, a second end of the second member is connected to a supply-contact device, such that, by means of a rotary motion of at least one of the first member or the second member electrical contact is made between contact elements of the supply-contact device and corresponding contact elements of a receiving-contact device of the battery-powered vehicle, the contact elements of the receiving-contact device are permanently connected to a vehicle roof or a side wall of the battery-powered vehicle.

24. The method according to claim 23, which further comprises moving the first and second members of the multi-membered manipulator in a swivel plane which runs substantially transverse to a longitudinal extension of the battery-powered vehicle.

25. The method according to claim 23, which further comprises providing a control device, wherein the rotary motion of at least one of the first member or the second member proceeds automatically, controlled by the control device.

26. The method according to claim 25, wherein the control device, in controlling the first and second rotary drives, takes into account a vehicle-position signal supplied by a position-detection device.

27. A battery-powered, non-rail bound vehicle, comprising:
a vehicle roof; and
a receiving-contact device permanently mounted on the vehicle roof or on a side wall of the vehicle and having elongated contact elements which are disposed either in a shape of a cross or in the shape of a rectangle.

28. The vehicle according to claim 27, further comprising a contact plate made from an electrical insulator and said elongated contact elements are embedded at least partially in said contact plate.
